(19) United States
(12) Patent Application Publication
(10) Pub. No.: US 2009/0065099 A1
(43) Pub. Date: Mar. 12, 2009

(54) CHEMICAL CONVERSION TREATING AGENT AND SURFACE TREATED METAL

(75) Inventors: Kazuhiro Makino, Tokyo (JP); Shinya Nishida, Tokyo (JP); Masanobu Futsuhara, Tokyo (JP); Toshiaki Shimakura, Tokyo (JP); Hiroshi Hosono, Aichi (JP)

Correspondence Address: CONNOLLY BOVE LODGE & HUTZ LLP, 1875 EYE STREET, N.W., SUITE 1100, WASHINGTON, DC, 20006, US

(73) Assignees: Nippon Paint Co., Ltd., Kita-ku, Osaka-shi (JP); Toyota Jidosha Kabushiki Kaisha, Aichi (JP)

(21) Appl. No.: 11/817,931

(22) PCT Filed: Mar. 6, 2006
(86) PCT No.: PCT/JP2006/304825

§ 371 Date: Oct. 21, 2008

(30) Foreign Application Priority Data
Mar. 7, 2005 (JP) 2005-062778

(51) Int. Cl. C23C 22/00; C23C 28/02; B32B 15/00

(52) U.S. Cl. 148/240; 148/22; 148/400

(57) ABSTRACT

It is an object of the invention to provide a chemical conversion treating agent containing no chromium and exhibiting high corrosion resistance and excellent stability.

A chemical conversion treating agent comprising:
zirconium; fluorine; (A) at least one compound selected from the group consisting of amino group-containing silane coupling agents, their hydrolyzed products, and their polymers; and (B) an amino group-containing water-borne phenol compound;
wherein the content of zirconium in the chemical conversion treating agent is 25 to 2000 ppm on the metal equivalent basis, and
the mole ratio of the contents of fluorine and zirconium satisfies the following relation:

3≦F/Zr≦6.

### TECHNICAL FIELD

The invention relates to a chemical conversion treating agent and a surface treated metal.

### BACKGROUND ART

In applying a cationic electrodeposition for the surface of a metal material, chemical conversion treatment is carried out to improve the coating film properties such as corrosion resistance, coating film adhesion and the like. With respect to chromate treatment employed in the chemical conversion treatment in terms of the improvement of the adhesion or corrosion resistance of the coating film, harmfulness of chromium has been pointed out in recent years, and it has been required to develop chromium-free chemical conversion treating agents. As such chemical conversion treating agents, metal surface treating agents comprising zirconium compounds have been known so far (e.g. reference to Japanese Kokai Publication Hei-7-310189).

However, a chemical conversion coat obtained by a metal surface treating solution comprising a zirconium compound is inferior in the adhesion to a coating film formed by a cationic electrodeposition or a powder coating, and therefore, in general, the chemical conversion treatment with the solution has scarcely been performed as pretreatment for such coating.

Further, such a metal surface treating solution comprising a zirconium compound is insufficient in the adhesion property particularly when applied to an iron based substrate, and it has been difficult to form a good chemical conversion coat on the iron-based substrate. Therefore, it is impossible to complete metal surface treatment of a product made of various kinds of metal materials such as iron, zinc, aluminum, and the like by only one step treatment and it is very inefficient in terms of the workability. Consequently, it has been desired to develop a chemical conversion treating agent which contains no chromium and can form a chemical conversion coat for a product made of various kinds of metal materials by only one step chemical conversion treatment.

Chemical conversion treating agents are disclosed in Japanese Kokai Publication 2004-190121 and Japanese Kokai Publication 2004-218070. However, such chemical conversion treating agents can not give sufficient corrosion resistance to iron-based substrates as steel plates hard to form chemical conversion coat, e.g. a hot rolled steel plate (SPH) and a high tensile strength steel (HTSS).

Further, a chemical conversion treating agent containing an amino group-containing silane coupling agent is disclosed in the Japanese Kokai Publication 2004-218070. Since a part of the amino group-containing silane coupling agent is condensation polymerized in a solution or inter-reacted with zirconium ion to form a precipitate of reaction product, there is a problem that the effect cannot be kept for a long duration. Therefore, at the time of practical use, it is required to carry out chemical conversion treatment with stabilizing the chemical conversion treating solution and accordingly it is inconvenient in terms of the workability.

### SUMMARY OF THE INVENTION

In view of the above-mentioned state of the art, it is an object of the invention to provide a chemical conversion treating agent containing no chromium and exhibiting high corrosion resistance and excellent stability.

The present invention provides to a chemical conversion treating agent comprising: zirconium; fluorine; (A) at least one compound selected from the group consisting of amino group-containing silane coupling agents, their hydrolyzed products, and their polymers; and (B) an amino group-containing water-borne phenol compound;

wherein the content of zirconium in the chemical conversion treating agent is 25 to 2000 ppm on the metal equivalent basis, and

the mole ratio of the contents of fluorine and zirconium satisfies the following relation:

3≦F/Zr≦6.

Preferably, a content of (A) at least one compound selected from the group consisting of amino group-containing silane coupling agents, their hydrolyzed products, and their polymers is 5 to 2000 ppm on the basis of the solids concentration.

Preferably, a content of (B) the amino group-containing water-borne phenol compound is 5 to 1000 ppm on the basis of the solids concentration.

Preferably, The chemical conversion treating agent further comprises at least one metal ion selected from the group consisting of magnesium ion, aluminum ion, zinc ion, ferrous ion, ferric ion, manganese ion, cobalt ion, strontium ion, and copper ion.

With respect to the chemical conversion treating agent, a total fluorine mole concentration M_{F} (mol/L) in a solution, a mole concentration M_{Me} (mol/L) of the metal ion Me contained in a solution, and a valence x of Me preferably satisfy the following relation:

−0.2≦M_{F}−Σ(x×M_{Me})≦0.2.

The chemical conversion treating agent preferably has pH of 2.0 to 6.0.

The present invention also provides a surface treated metal comprising a chemical conversion coat formed by the above-mentioned chemical conversion treating agent.

Preferably, the chemical conversion coat has a coat amount of 0.001 to 1 g/m² on the basis of the total amount of all metals supplied from the chemical conversion treating agent.

The present invention also provides a surface treatment method, comprising a step of carrying out a treatment using a chemical conversion treating agent comprising: zirconium; fluorine; (A) at least one compound selected from the group consisting of amino group-containing silane coupling agents, their hydrolyzed products, and their polymers; and (B) an amino group-containing water-borne phenol compound,

wherein the content of zirconium in the chemical conversion treating agent is 25 to 2000 ppm on the metal equivalent basis, and

the mole ratio of the contents of fluorine and zirconium satisfies the following relation:

3≦F/Zr≦6.

Preferably, the chemical conversion treating agent is adjusted to satisfy the following relation:

−0.2≦M_{F}−Σ(x×M_{Me})≦0.2

wherein M_{F} (mol/L) is a total fluorine mole concentration in a solution, M_{Me} (mol/L) is a mole concentration of the metal ion Me contained in a solution, and the reference character x is a valence of Me.

### DETAILED DESCRIPTION OF THE INVENTION

Hereinafter, the invention will be described more in detail.

The present invention provides a chemical conversion treating agent comprising zirconium; fluorine; (A) at least one compound selected from the group consisting of amino group-containing silane coupling agents, their hydrolyzed products, and their polymers; and (B) an amino group-containing water-borne phenol compound; containing no harmful heavy metal ion such as chromium, and having a mole ratio of the contents of fluorine and zirconium which satisfies the relation of 3≦F/Zr≦6.

Generally, it is supposed that in treating a metal substrate with a zirconium-containing chemical conversion treating agent, a metal ion is dissolved by metal dissolution reaction and interface pH increases, and thereby zirconium hydroxide or oxide is produced and precipitated on the substrate surface.

In the chemical conversion treating agent of the present invention, the adjusting mole ratio of the zirconium concentration and the fluorine concentration in the above-mentioned range promotes the metal dissolution reaction to enhance the coat deposition property of zirconium. Thus, the chemical conversion treating agent of the invention can give excellent corrosion resistance to a steel plate hard to form chemical conversion coat such as SPH or a high tensile strength steel plate.

It is supposed that the above-mentioned effect is caused as follows. The coat deposition reaction, which is defined as ZrF₆²⁻+nH₂O→ZrF₆₋ₙ, (OH)ₙ+nHF, tends to proceed easily in the direction shown with the arrow by adjusting the F/Zr ratio in a coating bath to decrease the F ion concentration, and consequently, the F content in the coat can be decreased with increasing the deposition amount of ZrF₆₋ₙ(OH)ₙ and a coat with a composition similar to Zr (OH)₄ can be formed, and thereby the property of the coat is improved. The corrosion resistance is increased as the coat amount of Zr(OH)₄ is increased. The adhesion to a coating film is decreased more when the F content in the ZrF₆₋ₙ(OH)ₙ coat is higher, because the F component existing in the outermost surface of the Zr coat form HF with water when water penetrates through the coating film. Consequently, decrease of the F ion amount in the bath makes the F content in the ZrF₆₋ₙ(OH)ₙ coat lower and improves the property after coating. If F/Zr ratio is too low, undesired precipitation of Zr(OH)₄ in the bath takes place and therefore, the effect of the invention can be caused by adjusting the F/Zr ratio in the range defined in the invention.

In the case of carrying out chemical conversion treatment by using the above-mentioned chemical conversion treating agent, since zirconium is to be precipitated in the substrate surface as a coat component as described above, it is required to adjust the mole ratio of the zirconium concentration and the fluorine concentration properly. Examples of a method for such adjustment may include methods comprising the steps of measuring the zirconium concentration and the fluorine concentration by ICP emission spectroscopy, atomic absorption spectrometry, titration, a fluorine ion meter, or the like; adjusting F/Zr mole ratio to be a prescribed ratio, if necessary, by adding a zirconium compound and a fluorine ion supplying compound; and adjusting pH with sodium hydroxide or the like. On the other hand, the adjustment of F/Zr ratio can be carried out by adding a compound having a high affinity with F ion such as aluminum ion and boron ion, to an aqueous H₂ZrF₆ solution to remove F ion from H₂ZrF₆.

The chemical conversion treating agent of the invention further comprises (A) at least one compound selected from the group consisting of amino group-containing silane coupling agents, their hydrolyzed products, and their polymers; and (B) an amino group-containing water-borne phenol compound. Since (B) the amino group-containing water-borne phenol compound has weak interactive function with (A) at least one compound selected from the group consisting of amino group-containing silane coupling agents, their hydrolyzed products, and their polymers, the compound (B) works as a stabilizer and can suppress the condensation polymerization reaction or the reaction with zirconium ion of (A) at least one selected from the group consisting of amino group-containing silane coupling agents, their hydrolyzed products, and their polymers. Owing to the function, the chemical conversion treating agent can stably exhibit the effect of (A) at least one compound selected from the group consisting of amino group-containing silane coupling agents, their hydrolyzed products, and their polymers.

Zirconium contained in the chemical conversion treating agent is a chemical conversion coat formation component. The formation of the chemical conversion coat comprising zirconium on a substrate improves the corrosion resistance and the wear resistance of the substrate and further increases the adhesion to a coating film to be formed successively in the next.

A supply source of the above-mentioned zirconium is not particularly limited and examples thereof include zirconium nitrate, zirconyl nitrate, zirconium sulfate, zirconyl sulfate, zirconyl chloride, zirconium chloride, zirconium carbonate, zirconyl carbonate, zirconium ammonium carbonate, zirconyl ammonium carbonate, and zirconium oxide.

The content of zirconium contained in the above-mentioned chemical conversion treating agent ranges from 25 ppm of a lower limit to 2000 ppm of an upper limit on the metal equivalent basis. When this content is less than the lower limit, performance of the chemical conversion coat to be obtained is inadequate, and when it exceeds the upper limit, anymore effect can not be expected and it is economically disadvantageous. The lower limit is preferably 40 ppm and the upper limit is preferably 1000 ppm.

Fluorine contained in the chemical conversion treating agent acts as an etchant of the substrate. A supply source of the fluorine is not particularly limited, and examples thereof include fluorides such as hydrofluoric acid, ammonium fluoride, fluoboric acid, ammonium hydrogen fluoride, sodium fluoride, sodium hydrogen fluoride and the like. In addition, an example of a complex fluoride includes hexafluorosilicates. Specific examples of hexafluorosilicates include fluorosilic acid, zinc hydrosilicofluoride, manganese hydrosilicofluoride, magnesium hydrosilicofluoride, nickel hydrosilicofluoride, iron hydrosilicofluoride, calcium hydrosilicofluoride and the like.

The mole ratio of the contents of fluorine and zirconium in the chemical conversion treating agent of the invention satisfies the following relation: 3≦F/Zr≦6. If the mole ratio is less than 3, the stability of zirconium ion is decreased and zirconium ion may possibly be precipitated. If the mole ratio exceeds 6, the stability of zirconium ion is so high as to decrease the precipitation amount of zirconium in form of a coat on the substrate surface and therefore, it is not preferable. Herein, the content of fluorine is calculated from the addition amount, however the amount of fluorine contained in the chemical conversion treating agent can directly be measured by a fluorine ion meter or the like.

The above-mentioned chemical conversion treating agent comprises (A) at least one compound selected from the group consisting of amino group-containing silane coupling agents, their hydrolyzed products, and their polymers. The above-mentioned amino group-containing silane coupling agents are compounds each having at least one amino group and a siloxane bond in one molecule. At least one compound selected from the group consisting of amino group-containing silane coupling agents, their hydrolyzed products, and their polymers (A) work on both of the chemical conversion coat and the coating film to improve the adhesion between them and thus give high corrosion resistance.

It is supposed that such an effect is attributed to absorption of a silanol group generated from hydrolysis of the amino group-containing silane coupling agent to the surface of the metal substrate through hydrogen bond and close adhesion of the chemical conversion coat with the metal substrate from the function of the amino group.

The above-mentioned amino group-containing silane coupling agents are not particularly limited and examples thereof include conventionally known silane coupling agents such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N,N-bis[3-(trimethoxysilyl)propyl]ethylenediamine, 3-aminopropyltripropoxysilane, N-2-(aminoethyl)-3-aminopropyltripropoxysilane, N-6-(aminohexyl)-3-aminopropyltrimethoxysilane, N-6-(aminohexyl)-3-aminopropyltriethoxysilane, N-6-(aminohexyl)-3-aminopropyltripropoxysilane, N-2-(aminoethyl)-11-aminoundecyltrimethoxysilane, N-2-(aminoethyl)-11-aminoundecyltriethoxysilane, N-2-(aminoethyl)-11-aminoundecyltripropoxysilane, N-3-[amino(polypropyleneoxy)]aminopropyltrimethoxysilane, N-3-[amino(polypropyleneoxy)]aminopropyltriethoxysilane, and N-3-[amino(polypropyleneoxy)]aminopropyltripropoxysilane. Commercialized amino group-containing silane coupling agents such as KBM-602, KBM-603, KBE-603, KBM-903, KBE-9103, KBM-573 (manufactured all by Shin-Etsu Chemical Co., Ltd.) and XS 1003 (manufactured by Chisso Corporation) are also usable.

Hydrolyzed products of the above-mentioned amino group-containing silane coupling agents can be produced by a conventionally known method which comprising the steps of, for example, dissolving an amino group-containing silane coupling agent in ion exchanged water and adjusting the obtained solution to be acidic with an optional acid. Commercialized products such as KBP-90 (manufactured by Shin-Etsu Chemical Co., Ltd., active ingredients: 32%) are also usable as the hydrolyzed products of amino group-containing silane coupling agents.

The polymers of the above-mentioned amino group-containing silane coupling agents are not particularly limited and commercialized products such as SILA ACE S-330 (γ-aminopropyltriethyoxysilane: manufactured by Chisso Corporation) and SILA ACE S-320 (N-(2-aminoethyl)-3-aminopropyltrimethoxysilane; manufactured by Chisso Corporation) can be exemplified.

The above-mentioned amino group-containing silane coupling agents and their hydrolyzed products are preferably used for pretreatment of coating particularly with a cationic electrocoating composition. The polymers of the amino group-containing silane coupling agents are preferably used for pretreatment of coating not only with a cationic electrocoating composition but also with a solvent coating composition, a water-borne coating composition, and a powder coating composition.

The addition amount of (A) at least one compound selected from the group consisting of amino group-containing silane coupling agents, their hydrolyzed products, and their polymers in the chemical conversion treating agent is preferably in a range from 5 ppm of a lower limit to 2000 ppm of an upper limit on the basis of the solids concentration. If it is less than 5 ppm, no sufficient coating film adhesion can be obtained and if it exceeds 2000 ppm, no further effect can be expected, resulting in economical disadvantage. The lower limit is more preferably 10 ppm and further more preferably 20 ppm. The upper limit is more preferably 1000 ppm and further more preferably 800 ppm.

The above chemical conversion treating agent comprises (B) an amino group-containing water-borne phenol compound. Owing to (B) the amino group-containing water-borne phenol compound, the above-mentioned amino group-containing silane coupling agents can exist stably in a solution and a prescribed effect can continuously be caused. Further, (B) the amino group-containing water-borne phenol compound contributes to improvement of the properties after coating. The amino group-containing water-borne phenol compound (B) can suppress permeation of water and corrosive ion by forming a thin film on the ZrF₆₋ₙ(OH), coat by crosslinking. Further, similarly to the amino group-containing silane coupling agents, (B) the amino group-containing water-borne phenol compound also forms a thin film on the ZrF₆₋ₙ(OH), coat, so that the effect of adhesion inhibition by F ion on the outermost surface of the Zr coat can be suppressed and the adhesion property after coating can be improved by formation of chemical bonds of amino group with the functional group in the coating film. That is, the chemical conversion treating agent is supposed to improve the property after coating owing to the synergetic functions of the adjustment of F/Zr ratio in the coating bath, addition of the amino group-containing silane coupling agent, and addition of (B) the amino group-containing water-borne phenol compound.

The amino group-containing water-borne phenol compound (B) is not particularly limited and examples to be used include amino group-containing phenol compounds such as aminophenols, nitroaminophenols, and aminothiophenols; and monomers, dimers, oligomers, and polymers of phenol resins having amino group in the skeletons. Further, amino group-containing cresol compounds may be used.

As (B) the amino group-containing water-borne phenol compound, commercialized products such as Sumilite Resin PR-NPK-225 series, 238 series, 246 series, 248 series, 249 series, 252 series, 260 series, and 261 (manufactured by Sumitomo Bakelite Co., Ltd.) can be used.

The addition amount of (B) the amino group-containing water-borne phenol compound in the chemical conversion treating agent is preferably in a range from 5 ppm of a lower limit to 1000 ppm of the upper limit on the basis of the solids concentration. If it is less than 5 ppm, no sufficient effect can be caused and if it exceeds 1000 ppm, any more effect cannot be expected and it is economically disadvantageous. The lower limit is more preferably 7 ppm and further more preferably 10 ppm. The upper limit is more preferably 800 ppm and further more preferably 600 ppm.

The weight ratio (A/B) of (A) at least one compound selected from the group consisting of amino group-containing silane coupling agents, their hydrolyzed products, and their polymers to (B) the amino group-containing water-borne phenol compound is preferably in a range from 1/20 to 20/1. The weight ratio is preferably in the above-mentioned range for satisfying both of the stability of the amino group-containing silane coupling agents and the property after coating.

Preferably, the chemical conversion treating agent of the present invention further contain at least one metal ion selected from the group consisting of magnesium ion, aluminum ion, zinc ion, ferrous ion, ferric ion, manganese ion, cobalt ion, strontium ion, and copper ion. Addition of these components can improve the corrosion resistance after coating and the coating film adhesion.

A supply source of the metal ion is not particularly limited and for example, nitrates, sulfates or fluorides may be added to the chemical conversion treating agent. Among them, nitrates are preferable because they do not cause any adverse effects on the chemical conversion reaction. The metal ion may be added inform of the above-mentioned compounds or may be metal ion eluted at the time of treating an object to be treated such as an iron-based substrate, an aluminum-based substrate, or a zinc-based substrate.

With respect to the chemical conversion treating agent, the total fluorine mole concentration M_{F} (mol/L) in a solution, the mole concentration Mme (mol/L) of the metal ion Me contained in a solution, and the valence x of Me are preferable to satisfy the following relation:

−0.2≦M_{F}−Σ(x×M_{Me})≦0.2.

In the case the above-mentioned metal ion is contained in the chemical conversion treating agent, the fluorine ion is consumed for forming a complex with the metal ion. The above-mentioned M_{F}−Σ(x×M_{Me}) expresses the etchable remaining fluorine mole concentration and if this remaining fluorine mole concentration is kept in the above-mentioned range, desirable good chemical conversion can be carried out. That is, the fluorine amount (x×M_{Me}) consumed for forming complexes with metal ions is calculated for every kind of metals from total fluorine mole concentration M_{F} and the remaining fluorine mole ratio calculated as the difference between the total of the fluorine amount Σ(x×M_{Me}) and the total fluorine mole concentration M_{F} is preferable in the above specified range. The total fluorine mole concentration M_{F} is calculated from the addition amount and may be the total fluorine amount contained in the chemical conversion treating agent and directly measured by a method, for example, ion chromatography. The mole concentration M_{Me} of the above-mentioned metal ion (Me) is a value measured by atomic absorption spectrometry, ICP or the like. In this connection, zirconium ion is not included in the metal ion (Me) in the above-mentioned relation.

The chemical conversion treating agent may further comprise an oxidizing agent. Addition of the oxidizing agent can cause effects of increasing the coat amount because the chemical conversion reaction is promoted; decreasing the porosity of the coating since a dense coating is to be formed; and accordingly improving the corrosion resistance. The oxidizing agent is not particularly limited and conventionally known oxidizing agents such as hydrogen peroxide (H₂O₂), persulfates (e.g. NaS₂O₈²⁻), nitrites (e.g. NaNO₂, KNO₂), and bromates (NaBrO₃, KBrO₃).

The chemical conversion treating agent of the present invention is preferably adjusted in such a way that its pH falls within a range from 2.0 of a lower limit to 6.0 of an upper limit. If the pH is lower than 2.0, etching is excessively carried out, and which makes chemical conversion inferior. If pH exceeds 6.0, etching is carried out insufficiently, and which makes chemical conversion inferior. The lower limit is more preferably 2.3 and the upper limit is more preferably 5.5. Since the chemical conversion treating agent of the present invention may contain a complex fluoride ion, nitrates, sulfates and fluoride salts as described above, it is preferred to add an alkaline component for adjusting the pH within the above-mentioned range. An alkaline component to adjust the pH is not particularly limited, and examples thereof include sodium hydroxide, potassium hydroxide, ammonia, amine compounds and the like.

Preferably, the chemical conversion treating agent of the present invention does not substantially contain phosphate ions. “Not containing substantially phosphate ions” means that phosphate ions are not contained to such an extent that they act as a component in the chemical conversion treating agent. When the chemical conversion treating agent does not substantially contain phosphate ions, phosphorous resulting in an environmental burden will not be substantially used and the formation of sludge such as iron phosphate, zinc phosphate and the like, which are produced in using a zinc phosphate treating agent, can be inhibited. Further, an environmental burden due to phosphorous vanishes and this is of great advantage to the workability of waste water treatment.

A method of treating a metal surface with the chemical conversion treating agent of the present invention is not particularly limited and it can be performed by bringing the chemical conversion treating agent into contact with the metal surface. A treatment method is not particularly limited, and examples thereof include an immersion method, a spray method, a roller coating method and the like.

In the above-mentioned treatment method, the treatment is preferably performed at a temperature of the chemical conversion treatment solution within a range from 20° C. of a lower limit to 70° C. of an upper limit. By performing a reaction within such a temperature range, a chemical conversion treatment reaction can be performed efficiently. The lower limit is more preferably 30° C. and the upper limit is more preferably 50° C. A treatment time, which varies with the concentration of the chemical conversion treating agent or the treatment temperature, is preferably 20 to 300 seconds.

In the above-mentioned treatment method, it is preferred to perform degreasing and post-degreasing rinsing treatment before the chemical conversion treatment with the chemical conversion treating agent, and to perform post-chemical conversion rinsing treatment after the chemical conversion treatment.

The degreasing treatment is generally carried out by immersing the substrate for about several minutes at room temperature to 50° C. in a degreasing agent such as a phosphorus-free and nitrogen-free cleaner in order to remove the oil or the stains adhering to the surface of the substrate. It is also possible to carry out pre-degreasing treatment prior to the degreasing as desired.

The post-degreasing rinsing treatment is performed by spraying once or more with a large amount of rinsing water in order to wash the degreasing treatment with water after the degreasing treatment.

The post-chemical conversion rinsing treatment is performed once or more in order not to adversely affecting the adhesion, the corrosion resistance and the like after subsequent various coatings. In the case of performing the post-chemical conversion rinsing treatment, it is appropriate that final rinsing is performed with pure water. In this post-chemical conversion rinsing treatment, the rinsing may be carried out by either spraying or immersion, or rinsing may be carried out in combination of these techniques.

In addition, the chemical conversion treatment in which the chemical conversion treating agent of the present invention is used is excellent also in terms of workability because it can be performed without carrying out the surface conditioning.

In the chemical conversion treatment using the chemical conversion treating agent of the present invention, a drying step is not always required after the above-mentioned post-chemical conversion rinsing treatment. Even though the chemical conversion coat is formed while being wet without carrying out the drying step, this does not have an adverse influence on performance to be attained. When the drying step is carried out, it is preferred to carry out cold air drying, hot air drying or the like. In case of the hot air drying, it is preferably carried out at a temperature of 300° C. or less in order to prevent the decomposition of organic substances.

Examples of a metal substrate treated with the chemical conversion treating agent of the present invention include iron-based substrates, aluminum-based substrates, zinc-based substrates and the like. An iron-based substrate, an aluminum-based substrate and a zinc-based substrate refer to an iron-based substrate which comprises iron and/or alloys thereof, an aluminum-based substrate which comprises aluminum and/or alloys thereof, and a zinc-based substrate which a comprises zinc and/or alloys thereof, respectively. The chemical conversion treating agent of the present invention can be used for the chemical conversion treatment of an article to be coated comprising a plurality of metal substrates of the iron-based substrate, the aluminum-based substrate and the zinc-based substrate.

The chemical conversion treating agent of the invention is desirable because an coating film which is excellent in adhesion can be formed on steel plates hard to form chemical conversion coat, such as iron-based substrates, especially a high tensile strength steel plate and a hot rolled steel plate (SPH), which are difficult to obtain a sufficient coating film adhesion with a common chemical conversion treating agent comprising zirconium. Accordingly, the agent is excellent in terms of the usability for the treatment of an object to be treatment comprising at least partially an iron-based substrate, particularly an object to be treated comprising at least partially SPH and a high tensile strength steel plate. A surface treated metal having a chemical conversion coat formed by the chemical conversion treating agent of the invention is also included in the invention.

The above-mentioned iron-based substrate is not particularly limited and for example, a cold-rolled steel plate, a hot-rolled steel plate, and a high tensile strength steel plate can be exemplified. The high tensile strength steel plate is a steel plate having increased tensile strength while maintaining good processibility by adding silica and manganese to iron and has a tensile strength of 340N/mm² or higher. Such a high tensile strength steel plate has low chemical conversion reactivity, so it is a material hard to be sufficiently treated in chemical conversion by a conventional metal surface treatment method. The chemical conversion treating agent of the invention can be used preferably for even for a high tensile strength steel plate with a tensile strength of 550 N/mm² or higher and also to a high tensile strength steel plate with a tensile strength of 600 N/mm² or higher. The above-mentioned high tensile strength steel plates have a higher content of silica or manganese as their tensile strength is higher and the reactivity of chemical conversion reaction tends to be decreased. Therefore, it is needed more to adjust the reactivity of the surface treating agent.

The above-mentioned aluminum-based substrate is not particularly limited, but examples thereof include #5000 series aluminum alloys and #6000 series aluminum alloys. The above-mentioned zinc-based substrate is not particularly limited, but examples thereof include zinc or zinc-based alloy-coated steel plates by zinc-based electrodeposition, hot dipping or vapor deposition coating, such as a zinc-coated steel plate, a zinc-nickel-coated steel plate, a zinc-iron-coated steel plate, a zinc-chromium-coated steel plate, a zinc-aluminum-coated steel plate, a zinc-titanium-coated steel plate, a zinc-magnesium-coated steel plate, and a zinc-manganese-coated steel plate.

The iron-based substrate, the aluminum-based substrate and the zinc-based substrate can be simultaneously chemically treated using the above-mentioned chemical conversion treating agent. As an article to be treated, which is treated with the chemical conversion treating agent of the present invention, an automobile body is particularly preferred and other metal products may also be treated.

The chemical conversion coat formed by using the chemical conversion treating agent of the present invention is preferable to have a coat amount in a range from the lower limit of 0.001 g/m² to the upper limit of 1 g/m² on the basis of the total amount of all metals supplied from the chemical conversion treating agent. If it is less than 0.001 g/m², no uniform chemical conversion coat can be obtained and therefore, it is not preferable. If it exceeds 1 g/m², it is economically disadvantageous. The lower limit is more preferably 0.005 g/m² and the upper limit is more preferably 0.8 g/m².

Coating, which can be applied to a metal substrate having a chemical conversion coat formed by the chemical conversion treating agent of the present invention, is not particularly limited and publicly known coating such as cationic electrodeposition, powder coating, and the like can be applied. Since the chemical conversion treating agent of the present invention can give good treatment to all metals such as iron, zinc, aluminum and the like, it can be suitably used particularly as pretreatment of cationic electrodeposition for an article to be treated comprising an iron-based substrate at least partially. The above-mentioned cationic electrodeposition is not particularly limited and publicly known cationic electrocoating compositions comprising an aminated epoxy resin, an aminated acrylic resin and a sulfonium introduced epoxy resin can be applied.

The above-mentioned metal substrate may be further coated by an intermediate coating and a top coating after the cationic electrodeposition. The above-mentioned intermediate coating may be carried out by applying a common intermediate coating composition comprising a coating film-formable resin and a curing agent, and if necessary, various kinds of organic and inorganic coloring pigments and extender pigments. The above-mentioned top coating may be carried out by applying a common solvent-borne clear coating composition comprising a coating film-formable resin and a curing agent.

The invention also provides a surface treatment method comprising a step of carrying out treatment using the chemical conversion treating agent of the invention. In the surface treatment method, the chemical conversion treating agent is preferable to be adjusted to satisfy the following relation:

−0.2−M_{F}−Σ(x×M_{Me})≦0.2

wherein M_{F} (mol/L) is the total fluorine mole concentration in a solution, M_{Me} (mol/L) is the mole concentration of the metal ion Me contained in a solution, and the reference character x is the valence of Me.

As described above, it is preferable to keep the etchable remaining fluorine concentration in a prescribed range so that fluorine in the chemical conversion treating agent is consumed for forming a complex with the metal ion to maintain the good state of chemical conversion. In the case the treatment is carried out continuously by the surface treatment method, metal ions such as iron ion, aluminum ion, and zinc ion are dissolved from the object substrate to be treated and accumulated in the chemical conversion treating agent. These metal ions may possibly deteriorate the state of chemical conversion if the remaining fluorine mole concentration is out of the above-mentioned range.

Therefore, the surface treatment method of the invention is preferable to be carried out while the above-mentioned remaining fluorine mole concentration (M_{F}−Σ(x×M_{Me})) within the above-mentioned range. The control method is not particularly limited and a method of adjusting it by adding the raw materials while the metal ion mole concentration is measured can be exemplified.

The chemical conversion treating agent of the present invention is a chemical conversion treating agent containing zirconium as a coating formable component and providing high corrosion resistance even to SPH and a high tensile strength steel plate, which are steel plates hard to form chemical conversion coat. Further, since the chemical conversion treating agent of the invention stably provides the coating film adhesion, chemical conversion treatment can be carried out advantageously in terms of the workability.

### EXAMPLES

Hereinafter, the present invention will be described in more detail by way of examples, but the present invention is not limited to these examples.

### Examples 1 to 6 and Comparative Examples 1 to 4

Commercialized cold rolled steel plates (SPCC-SD, manufactured by Nippon Test Panel Co., Ltd.; 70 mm×150 mm×0.8 mm), hot rolled steel plates (SPH, manufactured by Nippon Test Panel Co., Ltd.; 70 mm×150 mm×0.8 mm), high tensile strength steel plates (780 T HITEN, manufactured by Nippon Test Panel Co., Ltd.; 70 mm×150 mm×0.8 mm), hot-dipped zinc-coated (galvanized) steel plates (GA steel plates, manufactured by Nippon Test Panel Co., Ltd.; 70 mm×150 mm×0.8 mm), zinc-coated Al for automobiles (6K21, manufactured by Kobe Steel Ltd.; 70 mm×150 mm×0.8 mm) were used as substrates and the pretreatment of coating was carried out under the following conditions.

### (1) Pretreatment of Coating

Degreasing treatment: Each steel sheet was immersed in 2% by weight of “Surfcleaner 53” (a degreasing agent, manufactured by Nippon Paint Co., Ltd.) at 50° C. for 2 minutes.

Post-degreasing rinsing treatment: the sheet was treated for 30 seconds by spraying with tap water.

Chemical conversion treatment: A chemical conversion treating agents having the compositions shown in Table 1 was prepared. Zirconyl nitrate was used as a supply source of zirconium, a hydrofluoric acid was used as a supply source of fluorine, and each metal nitrate was used as a supply source of each metal ion. The following were used as amino group-containing silane coupling agents, A: 3-aminopropyltriethoxysilane; B: N-(2-aminoethyl)-3-aminopropyltrimethoxysilane; C: N-(2-aminoethyl)-3-aminopropyltriethoxysilane; and D: N-(2-aminoethyl)-3-aminopropylmethyldimethoxysilane. The following were used as the amino group-containing phenol compounds, A: o-aminophenol; B: Sumilite Resin PR-NPK-261; C: Sumilite Resin PR-NPK-260; D: Sumilite Resin PR-NPK-248; and E: aminothiophenol. The pH was adjusted to be 3. The temperature of the chemical conversion treating agents was adjusted to 40° C. and the substrates were immersed in the agents for 60 seconds.

Post-chemical conversion rinsing treatment: Each steel sheet was treated for 30 seconds by spraying with tap water. Further, the steel sheet was treated for 30 seconds by spraying with ion-exchanged water. After that, in wet state, the sheet was subjected to electrodeposition. The coat amount was analyzed on the basis of the total amount of the metals in the chemical conversion coat by using “XRF 1700” (a fluorescent X-ray analyzer, manufactured by Shimadzu Corporation) after the rising and drying the substrates at 80° C. for 5 minutes in an electric drying furnace. The mole concentration MME of the metal ions in the chemical conversion treating agents (mol/L) was measured by atomic absorption spectrometry.

### (2) Coating

After 1 m² of each substrate was treated with 1 L of each chemical conversion treating agent, the metal substrate was electrodeposited with “POWERNIX 110G” (a cationic electrocoating composition produced by Nippon Paint Co., Ltd.) in such a way that a dried film thickness was 20 μm, rinsed by spraying with tap water for 30 seconds and further with ion exchanged water for 10 seconds, and then baked by heating at 170° C. for 20 minutes to obtain each test plate.

### Evaluation Test

### (Bath State)

After 1 m² of each metal substrate was treated with 1 L of each chemical conversion treating agent, the turbidity in the chemical conversion treating agent was visually observed.

### (Secondary Adhesion Test (SDT))

After cutting the two longitudinally parallel slits reaching a basis material on the surface of each obtained test plate, the test plate was immersed in an aqueous 5% NaCl solution at 50° C. for 480 hours. After that, the slit portion was peeled off with a tape. The separation of the coating composition was observed.

⊚: separation width of less than 1 mm;
◯: separation width of 1 to less than 2 mm;
Δ: separation width of 2 to less than 3 mm; and
X: separation width of 3 mm or wider.

### (Combined Cycle Corrosion Test (CCT))

Each of the above-mentioned test plate was coated with previously diluted Orga P-30 Gray (tradename: a melamine curable intermediate coating composition, manufactured by Nippon Paint Co., Ltd.), which is previously diluted and measured for 25 seconds (using No. 4 Ford Cup and measured at 20° C.) in a dried film thickness of 35 μm, baked at 140° C. for 30 minutes, and cooled to room temperature. Next, the plate was coated with a top coating composition for automobiles (a solvent-borne clear coating composition, manufactured by Nippon Paint Co., Ltd.) in dried film thickness of 35 μm in one stage and cured for 7 minutes. Then, it was baked at 140° C. for 20 minutes in a dryer to obtain each test plate having the intermediate coating film and the top coating film. After each test plate was scratched with a cutter knife, the test plate was subjected to treatment cycle 60 times consisting of a wetting step 1 (2 hours, 40° C., 95% humidity), salt water spraying (2 hours, 5% aqueous NaCl solution, 35° C.), a drying step 1 (2 hours, 60° C.), a wetting step 2 (6 hours, 50° C., 95% humidity), a drying step 2 (2 hours, 60° C.), and a wetting step 3 (6 hours, 50° C., 95% humidity) and then the maximum swollen width in both sides of the cut part was measured.

The evaluation criteria were as follows:

⊚: 0 to less than 3 mm;
◯: 3 mm to less than 4 mm;
Δ: 4 mm to less than 5 mm; and
X: 5 mm or more.

### Comparative Example 5

A test plate was obtained in the same manner as in Example 1, except that a chemical conversion treating agent containing zirconium concentration of 200 ppm and adjusted to have pH of 3.0, at 45° C., and the free fluorine ion concentration of 1 ppm measured by a fluorine ion meter (IMG-55G, manufactured by Toa Denpa Kogyo Co., Ltd.) was used, and the substrate was immersed in the chemical conversion treating agent for 120 seconds. The total fluorine concentration in the chemical conversion treating agent used was 50 ppm.

### Comparative Example 6

A test plate was obtained in the same manner as in Example 1, except that surface conditioning was carried out at room temperature for 30 seconds using 0.1% by weight of Surf Fine 5N-8 (manufactured by Nippon Paint Co., Ltd.) after post-degreasing rinsing and the chemical conversion treatment was carried out at 35° C. for 2 minutes using Surf Dyne SD-6350 (zinc phosphate type chemical conversion treating agent, manufactured by Nippon Paint Co., Ltd.).

TABLE 1

| | | | | | | | amino group- | amino group- | | | | |
|---|---|---|---|---|---|---|---|---|---|---|---|---|
| | | | Zr | | | | containing | containing | | | | |
| | | | concen- | F/Zr | metal ion | | silane | phenol | coat | | | |
| | | | tration | (mole | concentration | M_{F} − | coupling | compound | amount | | | |
| | | material | (ppm) | ratio) | (ppm) | Σ(x × M_{Me}) | agent (ppm) | (ppm) | (mg/m²) | CCT | SDT | bath state |
| Ex- | 1 | SPC | 70 | 3.3 | Mg(100) | −0.006 | A(50) | A(10) | 56 | ⊚ | ⊚ | transparent |
| ample | 2 | SPH | 200 | 3 | — | 0.007 | B(150) | B(50) | 90 | ⊚ | ⊚ | transparent |
| | | GA | | | | | | | 85 | ⊚ | ⊚ | transparent |
| | | Aluminum | | | | | | | 60 | ⊚ | ⊚ | transparent |
| | 3 | HITEN | 100 | 3.8 | Al(100) | 0 | B(250) | C(100) | 90 | ⊚ | ⊚ | transparent |
| | 4 | SPC | 1800 | 5.8 | Mg(500) + Zn(500) | −0.08 | C(1000) | D(300) | 137 | ⊚ | ⊚ | transparent |
| | 5 | SPC | 500 | 4.5 | Al(200) + Sr(50) + | 0.02 | D(500) | E(80) | 108 | ⊚ | ⊚ | transparent |
| | | | | | Cu(10) | | | | | | | |
| | 6 | SPC | 200 | 3.9 | — | 0.013 | B(150) | B(50) | 89 | ⊚ | ⊚ | transparent |
| | Evaluation was carried out aftar 4-month storage at room temperature from chemical conversion treating agent preparation in Example 6. | | | | | | | | | | | |
| Com- | 1 | HITEN | 100 | 7 | — | 0.015 | A(50) | C(20) | 78 | X | Δ | transparent |
| parative | 2 | SPC | 500 | 2 | Al(500) | −0.05 | B(100) | A(35) | 110 | Δ | Δ | turbid |
| Ex- | 3 | SPH | 200 | 2.5 | Mg(100) + Al(300) | −0.22 | C(200) | B(50) | 0.9 | Δ | X | transparent |
| ample | 4 | SPC | 15 | 3 | — | 0.0005 | A(50) | — | 5.6 | X | X | transparent |
| | Evaluation was carried out after 4-month storage at room temperature | | | | | | | | | | | |
| | from chemical conversion treating agent preparation in Comparative Example 4. | | | | | | | | | | | |
| | 5 | SPC | 200 | 1.2 | — | 0.008 | — | — | — | X | X | turbid |

| | | | | | | |
|---|---|---|---|---|---|---|
| 6 | SPC | zinc phosphate treatment | 2.0 | ⊚ | ⊚ | generation |
| | | | | | | of sludge |

From Table 1, it was shown that the chemical conversion treating agents of the invention were capable of forming good chemical conversion coats even on a steel plate hard to form chemical conversion coat such as a high tensile strength steel plate, SPH, and the like.

### INDUSTRIAL APPLICABILITY

The present invention provides a chemical conversion treating agent capable of carrying out excellent chemical conversion treatment for any kinds of metals such as iron, zinc, and aluminum with a suppressed load on environments and excellent in the stability. The chemical conversion treating agent of the invention is suitably usable for a body of an automobile, and the like.

1. A chemical conversion treating agent comprising:
zirconium; fluorine; (A) at least one compound selected from the group consisting of amino group-containing silane coupling agents, their hydrolyzed products, and their polymers; and (B) an amino group-containing water-borne phenol compound;
wherein the content of zirconium in the chemical conversion treating agent is 25 to 2000 ppm on the metal equivalent basis, and
the mole ratio of the contents of fluorine and zirconium satisfies the following relation:
3≦F/Zr≦6.

2. The chemical conversion treating agent according to claim 1,
wherein a content of (A) at least one compound selected from the group consisting of amino group-containing silane coupling agents, their hydrolyzed products, and their polymers is 5 to 2000 ppm on the basis of the solids concentration.

3. The chemical conversion treating agent according to claim 1,
wherein a content of (B) the amino group-containing water-borne phenol compound is 5 to 1000 ppm on the basis of the solids concentration.

4. The chemical conversion treating agent according to claim 1,
which further comprises at least one metal ion selected from the group consisting of magnesium ion, aluminum ion, zinc ion, ferrous ion, ferric ion, manganese ion, cobalt ion, strontium ion, and copper ion.

5. The chemical conversion treating agent according to claim 1,
wherein a total fluorine mole concentration M_{F} (mol/L) in a solution, a mole concentration M_{Me} (mol/L) of the metal ion Me contained in a solution, and a valence x of Me satisfy the following relation:
−0.2≦M_{F}−Σ(x×M_{Me})≦0.2.

6. The chemical conversion treating agent according to claim 1,
which has pH of 2.0 to 6.0.

7. A surface treated metal, comprising
a chemical conversion coat formed by the chemical conversion treating agent according to claim 1.

8. The surface treated metal according to claim 7,
wherein the chemical conversion coat has a coat amount of 0.001 to 1 g/m² on the basis of the total amount of all metals supplied from the chemical conversion treating agent.

9. A surface treatment method,
comprising a step of carrying out a treatment using a chemical conversion treating agent comprising: zirconium; fluorine; (A) at least one compound selected from the group consisting of amino group-containing silane coupling agents, their hydrolyzed products, and their polymers; and (B) an amino group-containing water-borne phenol compound,
wherein the content of zirconium in the chemical conversion treating agent is 25 to 2000 ppm on the metal equivalent basis, and
the mole ratio of the contents of fluorine and zirconium satisfies the following reaction:
3≦F/Zr≦6.

10. The surface treatment method according to claim 9,
wherein the chemical conversion treating agent is adjusted to satisfy the following reaction:
−0.2≦M_{F}−Σ(x×M_{Me})≦0.2
wherein M_{F} (mol/L) is a total fluorine mole concentration in a solution, M_{Me} (mol/L) is a mole concentration of the metal ion Me contained in the solution, and the reference character x is a valence of Me.

11. The chemical conversion treating agent according to claim 2,
wherein a content of (B) the amino group-containing water-borne phenol compound is 5 to 1000 ppm on the basis of the solids concentration.

12. The chemical conversion treating agent according to claim 2,
which further comprises at least one metal ion selected from the group consisting of magnesium ion, aluminum ion, zinc ion, ferrous ion, ferric ion, manganese ion, cobalt ion, strontium ion, and copper ion.

13. The chemical conversion treating agent according to claim 3,
which further comprises at least one metal ion selected from the group consisting of magnesium ion, aluminum ion, zinc ion, ferrous ion, ferric ion, manganese ion, cobalt ion, strontium ion, and copper ion.

14. The chemical conversion treating agent according to claim 2,
wherein a total fluorine mole concentration M_{F} (mol/L) in a solution, a mole concentration M_{Me} (mol/L) of the metal ion Me contained in a solution, and a valence x of Me satisfy the following relation:
−0.2≦M_{F}−Σ(x×M_{Me})≦0.2.

15. The chemical conversion treating agent according to claim 3,
wherein a total fluorine mole concentration M_{F} (mol/L) in a solution, a mole concentration M_{Me} (mol/L) of the metal ion Me contained in a solution, and a valence x of Me satisfy the following relation:
−0.2≦M_{F}−Σ(x×M_{Me})≦0.2.

16. The chemical conversion treating agent according to claim 4,
wherein a total fluorine mole concentration M_{F} (mol/L) in a solution, a mole concentration M_{Me} (mol/L) of the metal ion Me contained in a solution, and a valence x of Me satisfy the following relation:
−0.2≦M_{F}−Σ(x×M_{Me})≦0.2.

17. The chemical conversion treating agent according to claim 2, which has pH of 2.0 to 6.0.

18. The chemical conversion treating agent according to claim 3, which has pH of 2.0 to 6.0.

19. The chemical conversion treating agent according to claim 4, which has pH of 2.0 to 6.0.

20. The chemical conversion treating agent according to claim 5, which has pH of 2.0 to 6.0.
